(19) United States
(12) Patent Application Publication
(10) Pub. No.: US 2007/0181147 A1
(43) Pub. Date: Aug. 9, 2007

(54) Processing-fluid flow measuring method

(76) Inventor: Keigo Satake, Koshi-Shi (JP)

Correspondence Address: SMITH, GAMBRELL & RUSSELL, 1850 M STREET, N.W., SUITE 800, WASHINGTON, DC, 20036, US

(21) Appl. No.: 11/493,038

(22) Filed: Jul. 26, 2006

(30) Foreign Application Priority Data
Aug. 1, 2005 (JP) 2005-222806

(51) Int. Cl. B08B 6/00; B08B 3/00; B08B 7/04

(52) U.S. Cl. 134/1.2; 134/18; 134/56 R

(57) ABSTRACT

An object to be processed such as a semiconductor wafer is processed by supplying a process fluid such as an ozone gas and a water vapor into a process vessel from a supply source through a supply pipe. During the process, a temperature of the process fluid flowing through the supply pipe is detected. By previously measuring and recording a relationship between a temperature of the process fluid and a flow rate of the process fluid, for example, a flow rate of the process fluid can be determined based on the detected temperature of the process fluid.

### BACKGROUND OF THE INVENTION

1. Field of the Invention

The present invention relates to a technique for determining a flow rate of a process fluid, such as a vapor, when the process fluid is used for processing semiconductor wafers or the like.

2. Description of the Related Art

Various process fluids including liquids, such as chemical liquids and cleaning liquids, gases, and vapors are generally used for processing objects to be processed, such as semiconductor wafers and LCD glass substrates (hereafter referred to as “wafers”). For example, a process fluid of a predetermined temperature is supplied into a process vessel at a predetermined flow rate for processing wafers accommodated in the process vessel.

In these processes, ultrasonic flowmeters and flow meters have been conventionally used for determining a flow rate of a process fluid (see, for example, JP2002-151458A and JP10-2768A).

In general, an ultrasonic flowmeter sends an ultrasonic wave from one side to a process fluid flowing through a pipe, and receives the ultrasonic wave on the other side to determine a velocity of the fluid. The ultrasonic flowmeter counts number of pulses corresponding to a flow velocity of the fluid, and displays the flow rate based on the velocity. Thus, a flow rate of a gas phase fluid cannot be determined. On the other hand, the flow meter determines a flow rate of a process fluid based on a visual observation of a float. However, detection of a flow rate of a vapor is impossible, when dew drops are formed.

Therefore, there has been a problem in that a flow rate of a process fluid, in particular, a vapor cannot be accurately determined by these ultrasonic flowmeter and flow meter.

### SUMMARY OF THE INVENTION

The present invention has been made in view of the above circumstances. The object of the present invention is to accurately determine a flow rate of a process fluid such as a vapor, when an object to be processed such as a wafer is processed with the process fluid.

In order to achieve this object, according to a first aspect of the present invention, there is provided a method of determining a flow rate of a process fluid when the process fluid is supplied into a process vessel from a supply source through a supply pipe to process an object to be processed, the method comprising the steps of:

detecting a temperature of the process fluid flowing through the supply pipe; and

determining a flow rate of the process fluid based on the detected temperature of the process fluid.

According to a second aspect of the present invention, there is provided a method of processing an object to be processed, by supplying a process fluid into a process vessel from a supply source of the process fluid through a supply pipe, wherein

the process is performed, while a temperature of the process fluid flowing through the supply pipe is detected, and a flow rate of the process fluid is monitored, the flow rate being determined based on the detected temperature of the process fluid.

In addition, there is provided a method of processing an object to be processed, by supplying into a process vessel a mixed fluid of a first process fluid and a second process fluid respectively supplied from a supply source of the first process fluid and a supply source of the second process fluid through a supply pipe, wherein

the process is performed, while a temperature of the mixed fluid is detected, and at least one of the flow rates of the first process fluid, the second process fluid, and the mixed fluid is monitored, the flow rate being determined by the detected temperature of the mixed fluid.

According to the above determining method and processing method, a flow rate of the process fluid or mixed fluid is determined based on a temperature of the process fluid or mixed fluid flowing through the supply pipe. Thus, even when the process fluid or mixed fluid includes bubbles or is in a gas phase, a flow rate thereof can be accurately determined. Since the process fluid or mixed fluid can be supplied into the process vessel at an accurate flow rate, improvement in process precision and improvement in reliability of a processing apparatus can be realized.

According to a third aspect of the present invention, there is provided a processing apparatus comprising:

a process vessel that accommodates an object to be processed;

a supply source of a process fluid;

a supply pipe through which the process fluid is supplied from the supply source into the process vessel;

a temperature sensor for detecting a temperature of the process fluid flowing through the supply pipe; and

a controller configured to monitor a flow rate of the process fluid, the flow rate being determined based on a temperature of the process fluid detected by the sensor.

In addition, there is provided a processing apparatus comprising:

a process vessel that accommodates an object to be processed;

a supply source of a first process fluid;

a supply source of a second process fluid;

a supply pipe in which the first and second process fluids supplied from the respective supply sources are mixed to each other, and through which supply pipe the mixed fluid is supplied into the process vessel;

a temperature sensor for detecting a temperature of the mixed fluid in the supply pipe; and

a controller configured to monitor at least one of the flow rates of the first process fluid, the second process fluid, and the mixed fluid, the flow rate being determined based on a temperature of the mixed fluid detected by the sensor.

According to the above processing apparatuses, the controller monitors a flow rate of the process fluid or mixed fluid which is determined based on a temperature of the process fluid or mixed fluid detected by the temperature sensor. Thus, even when the process fluid or mixed fluid includes bubbles or is in a gas phase, a flow rate thereof can be accurately monitored while the process is performed. Since the process fluid or mixed fluid can be supplied into the process vessel at an accurate flow rate, improvement in process precision and improvement in reliability of a processing apparatus can be realized.

According to a forth aspect of the present invention, there is provided a recording medium storing a program for executing, in the above processing apparatus, for example, the above processing method with the use of the process fluid or mixed fluid.

According to the present invention, even when the (second) process fluid is a vapor, a flow rate thereof can be accurately determined.

The present invention can be fulfilled by previously measuring and recording (storing in a controller) a relationship between a temperature of the process fluid (mixed fluid) and a flow rate of the process fluid (at least one of the first process fluid, the second process fluid, and the mixed fluid).

### BRIEF DESCRIPTION OF THE DRAWINGS

FIG. 1 is a schematic view of a processing apparatus according to the present invention;

FIG. 2 is a view of a main part of the processing apparatus shown in FIG. 1;

FIG. 3 is a perspective view of an attachment state of a temperature sensor on the processing apparatus shown in FIG. 1;

FIG. 4 is a graph showing changes in temperature of a mixed fluid relative to different flow rates of a water vapor in the processing apparatus shown in FIG. 1; and

FIG. 5 is a graph showing a relationship between a temperature of a mixed fluid and a flow rate of a water vapor, which is obtained based on the data shown in FIG. 4.

### DESCRIPTION OF PREFERRED EMBODIMENT

An embodiment of the present invention will be described in detail below with reference to the accompanying drawings. Given herein as an example to describe the process with a process fluid is a case where a semiconductor wafer as an object to be processed is processed such that a resist on a surface of the semiconductor wafer is made soluble in water (ozone process).

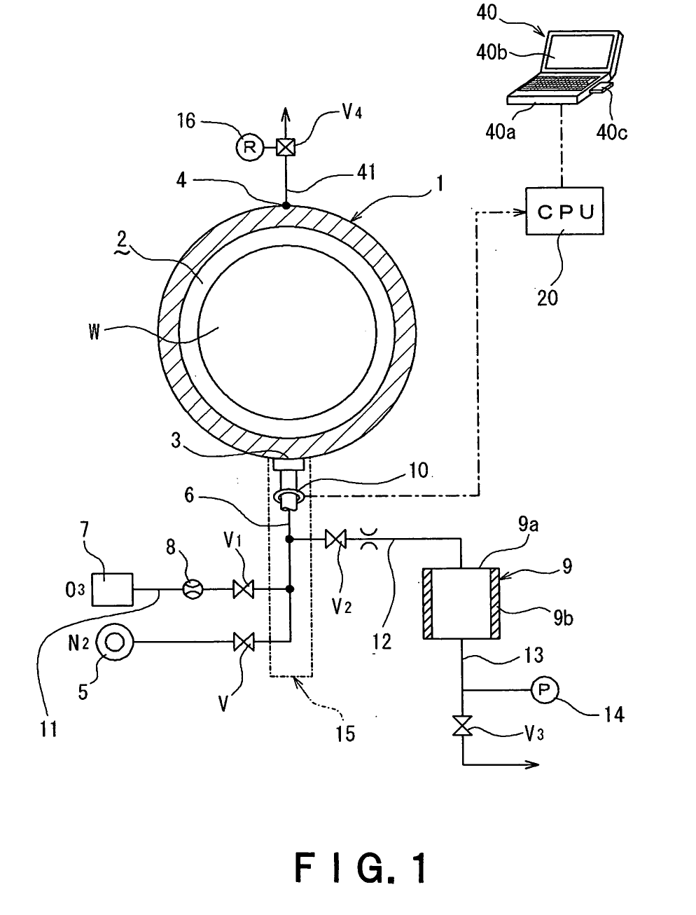

A processing apparatus shown in FIG. 1 includes a process vessel 1, a supply pipe 6, a supply source 5 of nitrogen (N₂) gas, a supply source 7 of ozone gas, a supply source 9 of water vapor, a temperature sensor 10, and a computer 40 as a controller. The computer 40 is provided with a central processing unit (CPU) 20.

The substantially cylindrical process vessel 1 defines therein a process chamber 2 for receiving a semiconductor wafer W. The process vessel 1 has a supply port 3 through which a process fluid is supplied and a discharge port 4 through which the process fluid is discharged. The supply port 3 and the discharge port 4 are formed in diametrically opposed positions. In the process vessel 1, there are disposed a heater (not shown) for heating an inside of the process chamber 2 and a lid (not shown) capable of opening and closing the process vessel 1. The supply pipe 6 is connected to the supply port 3 of the process vessel 1. A discharge pipe 41, which has a relief valve V4 adjusted by a regulator 16, is connected to the discharge port 4.

The N₂ gas supply source 5 is connected to the supply pipe 6 via an on-off valve V. The ozone generator 7 which is the supply source of ozone gas as a first process fluid is connected to the supply pipe 6 through a first connecting pipe 11 provided with an on-off valve V1 and a flowmeter 8. The vapor generator 9 which is the supply source of water vapor as a second process fluid is connected to the supply pipe 6 through a second connecting pipe 12 provided with an on-off valve V2.

The temperature sensor 10 for detecting a temperature of a fluid passing through the supply pipe 6 is attached on a downstream side of the supply pipe 6. The temperature sensor 10 is electrically connected to the CPU 20 of the computer 40. The computer 40 monitors a flow rate of the water vapor which is determined based on a temperature of a mixed fluid detected by the temperature sensor 10. For example, the CPU 20 of the computer 40 is configured to judge that a flow rate of the water vapor reaches a reference flow rate suitable for processing the wafer when a temperature of the mixed fluid reaches a reference temperature.

The vapor generator 9 includes a generator body 9a connected to a not-shown pure water supply source, and a heater 9b disposed on an outer periphery of the generator body 9a. A discharge pipe 13 provided with a pressure sensor 14 and a pressure adjusting valve V3 is connected to the generator body 9a. The vapor generator 9 is adapted to generate a water vapor having a temperature of, for example, about 130° C. Since a pressure in the process chamber 2 is controlled by the relief valve V4 adjusted by the regulator 16, a supply rate of the water vapor can be controlled due to a pressure difference between the pressures in the process chamber 2 and the vapor generator 9.

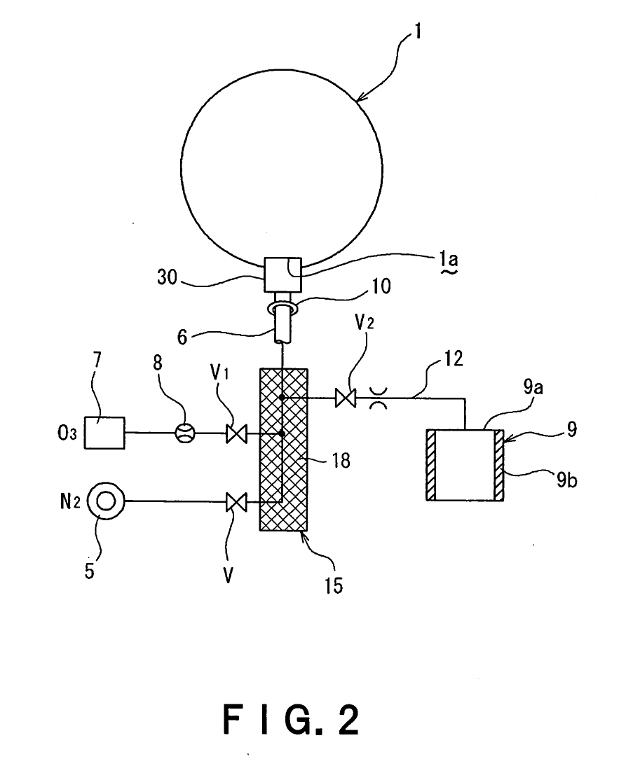

As shown in FIG. 2, a heat retainer 18, which is made of a heat insulating material with a heater being embedded therein, for example, is mounted on a fluid mixing part 15 which is a connecting part where the first connecting pipe 11 and the second connecting pipe 12 are connected to each other in the supply pipe 6. The heat retainer 18 retains a temperature of the fluid mixing part 15 at, e.g., 150° C. so as to prevent formation of dew drops on the supply pipe 6, which might otherwise occur due to a temperature difference between the temperature of the fluid mixing part 15 and an atmospheric temperature (e.g., about 60° C.). The temperature sensor 10 is directly attached on a surface of the supply pipe 6 at a position near the process vessel 1. The temperature sensor 10 can detect temperatures of fluids passing through the supply pipe 6, that is, temperatures of the ozone gas, the water vapor, and the mixed fluid of the ozone gas and the water vapor. The temperature sensor 10 may be embedded in the heat insulating material of the heat retainer 18.

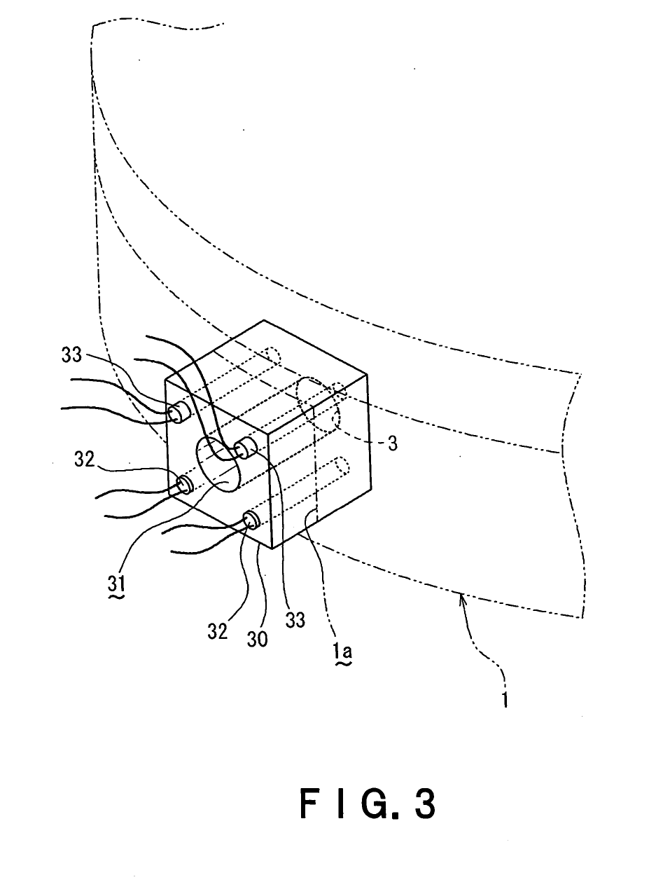

As shown in FIG. 3, a recess 1a is formed in the process vessel 1 at a position around the supply port 3. A cuboid block 30 made of aluminum is fitted in the recess 1a. The block 30 includes a communication channel 31 in communication with the supply port 3 and the supply pipe 6. Two heaters 32 are embedded in a lower part of the block 30, and two temperature sensors 33 are embedded in an upper part of the block 30. Thus, a temperature of the cuboid block 30 is retained at, e.g., 150° C. so as to prevent formation of dew drops, which might otherwise occur due to a temperature difference between the temperature of the cuboid block 30 and an atmospheric temperature.

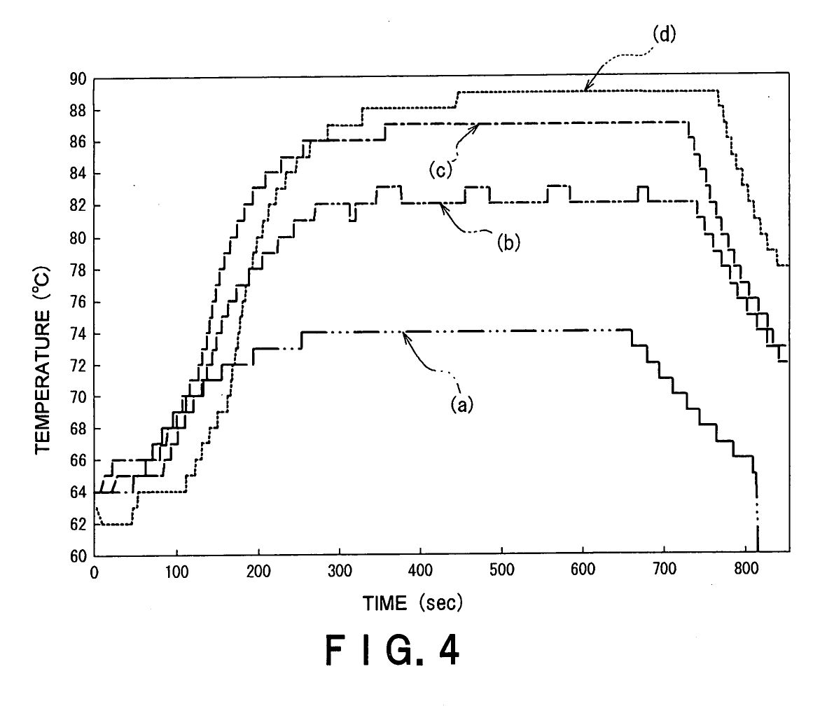

A previously measured relationship between a temperature of the mixed fluid and a flow rate of the water vapor is stored in the computer 40 (for example, in a memory such as a hard disk drive in the computer 40). This relationship can be experimentally measured in advance. For example, changes in temperature of the mixed fluid were examined by the sensor 10 for the following cases in which mass flow rates of the water vapor to be supplied into the process chamber 2 were (a) 0 g/min, (b) 2.3 g/min, (c) 4.2 g/min, and (d) 6.2 g/min. The results are shown in FIG. 4. A temperature difference between the case (b) 2.3 g/min and the case (c) 4.2 g/min was about 4° C. A temperature difference between the case (c) 4.2 g/min and the case (d) 6.2 g/min was about 2° C. In these cases, a flow rate of the ozone gas is monitored by the flowmeter 8.

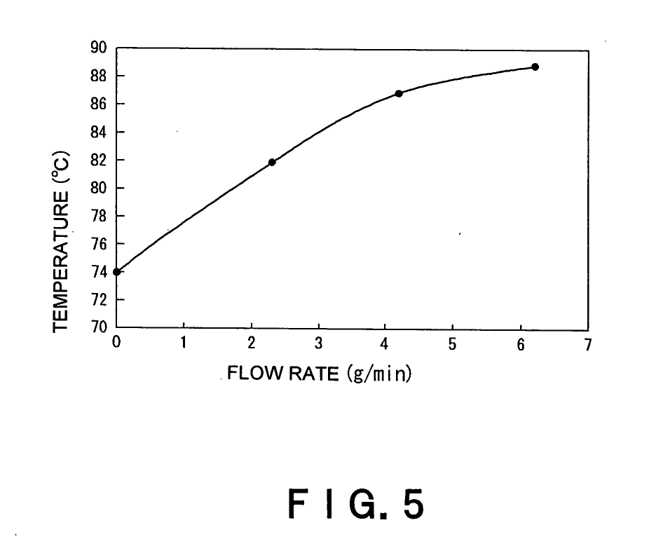

FIG. 5 shows a relationship between temperature of the mixed fluid and a flow rate of the water vapor, which is obtained from the data shown in FIG. 4. By means of the computer 40 which stores this relationship beforehand, it is possible to monitor a flow rate of the water vapor which is determined based on a temperature of the mixed fluid detected by the temperature sensor 10. For example, the CPU 20 of the computer 40 can judge whether the water vapor is supplied into the process chamber 2 or not, based on changes in temperature of the mixed fluid. In addition, the CPU 20 can judge that a flow rate of the water vapor reaches a reference flow rate suited for processing, when a temperature of the mixed fluid reaches a reference temperature.

In addition to the relationship between a temperature of the mixed fluid and a flow rate of the water vapor, the computer 40 stores a relationship between a temperature and a flow rate of the ozone gas when only the ozone gas is supplied, and information as to a temperature detected by the sensor 10 when neither water vapor nor ozone gas is supplied.

As shown in FIG. 1, for example, the computer 40 is provided with an input/output part 40a, a display part 40b, and a recording (storage) medium 40c, which are connected to the CPU 20. The display part 40b displays an input image through which processing data used in the processing apparatus are inputted. A computer-readable control program executed by the CPU 20 is stored in the recording medium 40c.

The recording medium 40c may be built in the input/output part 40a of the computer 40, or may be removably fixed on the input/output part 40a and may be readable by a reader mounted thereon. In the most typical case, the recording medium 40c is a hard disk drive in which a control program has been installed by an operator of a manufacturing company of the processing apparatus. In another case, the storing medium 40c is an optically readable removable disk such as a CD-ROM or DVD-ROM in which a control program has been written. The recording medium 40c may either be of a RAM (random access memory) type or a ROM (read only memory) type. Alternatively, the recording medium 40c may be a cassette type ROM. In short, any recording medium known in the technical field of a computer can be employed as the recording medium 40c.

In a factory where a plurality of processing apparatuses are placed, a control program may be stored in an executive computer that comprehensively controls the computers 40 in the respective processing apparatuses through communication lines.

Next, contents and procedures of a process performed by the processing apparatus will be described below.

The wafer W taken out from a not-shown carrier is loaded into the process chamber 2, and the process vessel 1 is hermetically sealed. Under this state, the wafer W is heated by the heater disposed on the process vessel 1 for about 30 seconds, so that a temperature of the wafer W is rapidly raised to near a process temperature (about 105° C.) (pre-heating step). This step can facilitate the following resist water-solubilization process (ozone process) for the wafer W.

Thereafter, an ozone gas of a predetermined concentration is supplied from the ozone gas generator 7 into the process chamber 2 through the first connecting pipe 11 and the supply pipe 6. Meanwhile, a flow rate of an atmosphere discharged from the process chamber 2 through the discharge pipe 41 is adjusted by the relief valve V4. By discharging the atmosphere from the process chamber 2 while supplying the ozone gas thereinto, an inside of the process chamber 2 is made into an ozone gas atmosphere with a pressure therein being held constant. In this step, the pressure in the process chamber 2 is kept at, e.g., 0.2 Pa of gauge pressure, which is higher than the atmospheric pressure. The heater of the process vessel 1 maintains the atmosphere in the process chamber 2 and the temperature of the wafer W. The atmosphere in the process chamber 2 discharged through the discharge pipe 41 is discharged to an ozone gas processing system. In this manner, the process chamber 2 is filled with the ozone gas of a predetermined condensation (ozone gas filling step).

After the process chamber 2 is filled with the ozone gas, an ozone gas is continuously supplied. In this state, a water vapor is started to be supplied to the supply pipe 6 from the water vapor generator 9 through the second connecting pipe 12. Thus, a mixed fluid of the ozone gas and the water vapor is supplied into the process chamber 2 through the supply pipe 6 so as to perform a resist water-solubilization process (ozone process) for the wafer W (ozone processing step).

At this ozone processing step, a monitoring operation by the computer 40 starts after a predetermined standby period of time elapses from the start of the water vapor supply. The standby period is decided in accordance with a prescribed temperature reaching period which is obtained based on a previously determined temperature gradient data. During this monitoring operation, a temperature of the mixed fluid of the ozone gas and the water vapor flowing through the supply pipe 6 is detected by the temperature sensor 10, and the data relating to the detected temperature are transmitted to the computer 40. Based on the transmitted detected temperature, the computer 40 monitors a flow rate of the water vapor (which is determined based on the previously stored relationship between a temperature of the mixed fluid and a flow rate of the water vapor). To be specific, the computer 40 monitors whether the water vapor is supplied or not, or whether a flow rate of the water vapor reaches a reference flow rate for processing or not (whether a flow rate of the water vapor falls within a reference flow rate range or not). When a flow rate of the water vapor reaches the reference flow rate (falls within the reference flow rate range), the process is continued. Otherwise, a warning signal or the like is given. During the supply of a water vapor, a flow rate of the water vapor is kept monitored.

Also in this step, the pressure in the process chamber 2 is kept at, e.g., 0.2 Pa of gauge pressure, which is higher than the atmospheric pressure. The heater of the process vessel 1 maintains the atmosphere in the process chamber 2 and the temperature of the wafer W. In this manner, a resist applied to the surface of the wafer W is made soluble in water by the mixed fluid of the ozone gas and the water vapor in the process chamber 2 (resist water-solubilization step).

After the resist water-solubilization process (ozone process) is completed, the on-off valves V1 and V2 are closed at first. Then, the on-off valve V is opened and the relief valve V4 is opened. While the atmosphere in the process chamber 2 is discharged, a large amount of N₂ gas is supplied into the process chamber 2 from the N₂ gas supply source 5 so as to purge atmospheres in the supply pipe 6, the process chamber 2, and the discharge pipe 41 by means of the N₂ gas. In this manner, the mixed fluid of the ozone gas and the water vapor is discharged from the process chamber 2 (discharging step).

At this time, it is possible to find a malfunction of the on-off valve V2, by continuously monitoring a temperature detected by the temperature sensor 10. That is, when a temperature detected by the temperature sensor 10 is not lowered to a certain temperature, it can be estimated that the on-off valve V2 is not closed because of some accident.

Thereafter, the wafer W is unloaded from the process chamber 2 (wafer unloading step), and a series of processes for the wafer W is finished. Following thereto, it is possible to load a new wafer W into the process chamber 2 to similarly perform the resist water-solubilization process (ozone process). The wafer W which has been subjected to the resist water-solubilization process is transferred to a cleaning system, not shown, in which the wafer W is cleaned and dried.

When the computer 40 stores data including a plurality of correspondent relationships between temperatures and flow rates of a fluid as shown in FIG. 5, it is possible to grasp flow rates other than a reference flow rate.

In this embodiment, an object to be processed is a semiconductor wafer. However, needless to say, the present invention can be applied to another object to be processed, such as an LCD substrate, a reticle substrate used as a photomask, and so on.

1. A method of determining a flow rate of a process fluid when the process fluid is supplied into a process vessel from a supply source through a supply pipe to process an object to be processed, the method comprising the steps of:
detecting a temperature of the process fluid flowing through the supply pipe; and
determining a flow rate of the process fluid based on the detected temperature of the process fluid.

2. The flow rate determining method according to claim 1, wherein
the process fluid is a vapor.

3. The flow rate determining method according to claim 1, wherein
a relationship between a temperature of the process fluid and a flow rate of the process fluid is previously measured and recorded.

4. A method of processing an object to be processed, by supplying a process fluid into a process vessel from a supply source of the process fluid through a supply pipe, wherein
the process is performed, while a temperature of the process fluid flowing through the supply pipe is detected, and a flow rate of the process fluid is monitored, the flow rate being determined based on the detected temperature of the process fluid.

5. The processing method according to claim 4, wherein
when the detected temperature of the process fluid reaches a reference temperature, it is judged that a flow rate of the process fluid reaches a reference flow rate.

6. The processing method according to claim 4, wherein
the process fluid is a vapor.

7. The processing method according to claim 4, wherein
a relationship between a temperature of the process fluid and a flow rate of the process fluid is previously measured and recorded.

8. A method of processing an object to be processed, by supplying into a process vessel a mixed fluid of a first process fluid and a second process fluid respectively supplied from a supply source of the first process fluid and a supply source of the second process fluid through a supply pipe, wherein
the process is performed, while a temperature of the mixed fluid is detected, and at least one of the flow rates of the first process fluid, the second process fluid, and the mixed fluid is monitored, the flow rate being determined by the detected temperature of the mixed fluid.

9. The processing method according to claim 8, wherein
when the detected temperature of the mixed fluid reaches a reference temperature, it is judged that at least one of the flow rates of the fluids reaches a reference flow rate, and
the process is continued.

10. The processing method according to claim 8, wherein
the second process fluid is a vapor.

11. The processing method according to claim 8, wherein
a relationship between a temperature of the mixed fluid and at least one of the flow rates of the first process fluid, the second process fluid, and the mixed fluid is previously measured and recorded.

12. A processing apparatus comprising:
a process vessel that accommodates an object to be processed;
a supply source of a process fluid;
a supply pipe through which the process fluid is supplied from the supply source into the process vessel;
a temperature sensor for detecting a temperature of the process fluid flowing through the supply pipe; and
a controller configured to monitor a flow rate of the process fluid, the flow rate being determined based on a temperature of the process fluid detected by the sensor.

13. The processing apparatus according to claim 12, wherein
the controller is configured to judge that a flow rate of the process fluid reaches a reference flow rate when the detected temperature of the process fluid reaches a reference temperature.

14. The processing apparatus according to claim 12, wherein
the process fluid is a vapor.

15. The processing apparatus according to claim 12, wherein
a previously measured relationship between a temperature of the process fluid and a flow rate of the process fluid is stored in the controller.

16. A processing apparatus comprising:
a process vessel that accommodates an object to be processed;
a supply source of a first process fluid;
a supply source of a second process fluid;
a supply pipe in which the first and second process fluids supplied from the respective supply sources are mixed to each other, and through which supply pipe the mixed fluid is supplied into the process vessel;
a temperature sensor for detecting a temperature of the mixed fluid in the supply pipe; and
a controller configured to monitor at least one of the flow rates of the first process fluid, the second process fluid, and the mixed fluid, the flow rate being determined based on a temperature of the mixed fluid detected by the sensor.

17. The processing apparatus according to claim 16, wherein
the controller is configured to judge that at least one of the flow rates of the fluids reaches a reference flow rate, and continue the process when the detected temperature of the mixed fluid reaches a reference temperature.

18. The processing apparatus according to claim 16, wherein
the second process fluid is a vapor.

19. The processing apparatus according to claim 16, wherein
a previously measured relationship between a temperature of the mixed fluid and at least one of the flow rates of the first process fluid, the second process fluid, and the mixed fluid is stored in the controller.

20. The processing apparatus according to claim 16, further comprising a heat retainer retaining a heat in the supply pipe.

21. A recording medium storing a control program executable by a controller of a processing apparatus, the control program being configured to perform a process in which an object to be processed is processed by supplying a process fluid into a process vessel from a supply source of the process fluid through a supply pipe, while detecting a temperature of the process fluid flowing through the supply pipe, and monitoring a flow rate of the process fluid, the flow rate being determined based on the detected temperature of the process fluid.

22. The recording medium according to claim 21, wherein
the control program is configured to judge that a flow rate of the process fluid reaches a reference flow rate when the detected temperature of the process fluid reaches a reference temperature.

23. A recording medium storing a control program executable by a controller of a processing apparatus, the control program being configured to perform a process in which an object to be processed by supplying into a process vessel a mixed fluid formed by mixing a first process fluid and a second process fluid respectively supplied from a supply sources of the first process fluid and a supply source of the second process fluid through a supply pipe, while detecting a temperature of the mixed fluid, and monitoring at least one of the flow rates of first process fluid, the second process fluid, and the mixed fluid, the flow rate being determined by the detected temperature of the mixed fluid.

24. The recording medium according to claim 23, wherein
the control program is configured to judge that at least one of the flow rates of the fluids reaches a reference flow rate, and continue the process when the detected temperature of the mixed fluid reaches a reference temperature.
